(19) United States
(12) Patent Application Publication
(10) Pub. No.: US 2012/0183156 A1
(43) Pub. Date: Jul. 19, 2012

(54) MICROPHONE SYSTEM WITH A HAND-HELD MICROPHONE

(75) Inventors: Daniel Schlessinger, San Francisco, CA (US); Daniel Harris, San Francisco, CA (US); Jürgen Peissig, Hannover (DE); Achim Gleissner, Diekholzen (DE); Charles Windlin, Zurich (CH)

(73) Assignee: Sennheiser electronic GmbH & Co. KG, Wedemark (DE)

(21) Appl. No.: 13/005,682

(22) Filed: Jan. 13, 2011

(51) Int. Cl. H04R 3/00

(52) U.S. Cl. 381/111

(57) ABSTRACT

A microphone system is provided. The microphone system comprises at least one hand-held microphone and a base station. Audio signals detected by the hand-held microphone are forwarded to the base station. The hand-held microphone comprises a motion detection unit for detecting a motion or a gesture of a hand-held microphone. A control signal generating unit generates control signals based on the detected motion or gesture of the hand-held microphone. The hand-held microphone is adapted to forward the detected motion or gesture or the control signals to the base station. The output audio signal of the hand-held microphone can be manipulated based on the control signals. The hand-held microphone comprises an activation unit for activating or deactivating the motion detection unit or for activating or deactivating the transmission of the control signals.

The present invention relates to a microphone system with a hand-held microphone.

DE 10 2006 004 488 A1 discloses a hand-held microphone with a motion sensing unit. Depending on the sensed motion, the output of the microphone can be adjusted or influenced.

It is an object of the present invention to provide a microphone system with a hand-held microphone with an improved sound manipulation capability.

This object is solved by a microphone system according to claim 1, a hand-held microphone for a microphone system according to claim 6 and by a method of controlling a microphone system according to claim 7.

Therefore, a microphone system is provided. The microphone system comprises at least one hand-held microphone and a base station. Audio signals detected by the hand-held microphone are forwarded to the base station. The hand-held microphone comprises a motion detection unit for detecting a motion or a gesture of a hand-held microphone. A control signal generating unit generates control signals based on the detected motion or gesture of the hand-held microphone. The hand-held microphone is adapted to forward the detected motion or gesture or the control signals to the base station. The output audio signal of the hand-held microphone can be manipulated based on the control signals. The hand-held microphone comprises an activation unit for activating or deactivating the motion detection unit or for activating or deactivating the transmission of the control signals.

According to an aspect of the invention, the base station is adapted to transmit a feedback signal to the hand-held microphone which can give a feedback to the user upon receipt of the feedback signal. Accordingly, a feedback to the user can be provided.

According to a further aspect of the invention, the microphone system comprises an audio processing unit for processing or manipulating the output audio signal of the microphone depending on the control signals. The control signals can be based on a motion or gesture of the microphone or the activation of buttons or sliders on the microphone. Accordingly, the output audio sound signals of the microphone can be manipulated based on the motion or a gesture of the hand-held microphone or alternatively by means of an actuation of buttons or sliders provided on the hand-held microphone.

According to a further aspect of the invention, external devices coupled to the base station can be controlled based on the control signals.

According to a further aspect of the invention, the motion detection unit comprises a three-phase accelerometer for detecting the acceleration of the microphone and a three-axis gyro sensor. Based on the output of the accelerometer and the gyro sensor, the control signals of the microphone can be adapted.

The invention also relates to a hand-held microphone for a microphone system. The hand-held microphone comprises a microphone head and a motion detection unit for detecting a motion or gesture of the hand-held microphone. The hand-held microphone furthermore comprises at least one segment having knobs or sliders which upon actuation by the user influence the control signals of the hand-held microphone. Furthermore, a control signal generating unit is provided for generating control signals based on the detection motion or gesture of a microphone. The hand-held microphone is furthermore adapted to forward the detected motion or gesture or the control signals to the base station.

The invention also relates to a method of controlling a microphone system having at least one hand-held microphone and a base station. The hand-held microphone comprises an activation unit for activating or deactivating a motion detection unit or the transmission of control signals. A motion or gesture of the hand-held microphone is detected by a motion detection unit. Control signals based on the detected motion or gesture of the microphone are generated. The detected motion or gesture of the microphone or control signals are forwarded to the base station. The output signals of the hand-held microphone can be manipulated based on the control signals.

The invention relates to the idea to provide a microphone system with at least one hand-held microphone, wherein the microphone comprises a motion detection unit. Depending on the motion of the microphone or any gestures performed by the microphone, control signals are generated and the output signal of the microphone can be manipulated based on these control signals. The motion detection unit can comprise a gyro sensor and an accelerometer. The manipulation of the audio signal can be performed in the hand-held microphone or in a corresponding base station. The hand-held microphone can comprise an activation unit for activating the motion detection unit or the forwarding of the control signals to the base station. If the activation unit has not been activated, then no control signals will be forwarded. However, if the activation unit has been activated, the movement or gestures of the microphone will generate control signals based on which the audio signals of the microphone can be manipulated. Optionally, a feedback can be provided from the base station to the microphone if it has received control signals from the microphone. The feedback can be visual or vibrational or a haptic feedback.

Optionally, the orientation of the microphone can be used to control a reproduction of the audio signals from the microphone.

The hand-held microphone can comprise a microphone head, a motion detection unit and several different segments comprising knobs, sliders, etc. The knobs or sliders can be used to generate control signals based on which in turn the audio signals can be manipulated.

The invention also relates to the idea that a microphone is typically handled on stage and is moved or touched by the user or performer. The user can use his hands or fingers to catch and manipulate any kind of mechanical control attached to the microphone handle. The touch and manipulation can be detected and respective control signals can be generated to manipulate the output sound. Accordingly, the microphone handle can become something like a hand-held instrument to be played by finger or hand action. The finger or hand action can be recorded by mechanical (knobs, accelerators, gyros), haptical, optical, capacitive pick-ups or the like. An optical, haptical or vibrational feedback can be provided to enable a feedback for the performer.

By means of the hand-held microphone according to the invention, certain effects can be controlled like musical effects (e.g. reverb, echo, doubling, distortion, etc.), sound control effects (e.g. looping start/stop, instrument channel selection, sequencing controllers, etc.), non-acoustical effects (e.g. spot light control, smoke, visual displays, firework and other non-audio experiences perceived by the audience). The mechanical controllers which can be attached or arranged at the hand-held microphone can be knobs (mechanical and touch-sensitive), sliders (mechanical and capacitive), accelerometers and gyros and pressure-sensitive areas.

The invention also relates to providing controllers and appropriate signal processing to offer a user a maximum range of freedom in his artistic expression and a secure control. Furthermore, according to the invention, the controlling elements (knobs, sliders, motion sensors, etc.) can be freely configured to any human movement characteristic (click speed, turn or slide speed, movement, strength and length, etc.). These movement characteristics can be transferred into a parameter scale (e.g. 0-127).

This object is achieved by a hand-held microphone according to claim 1.

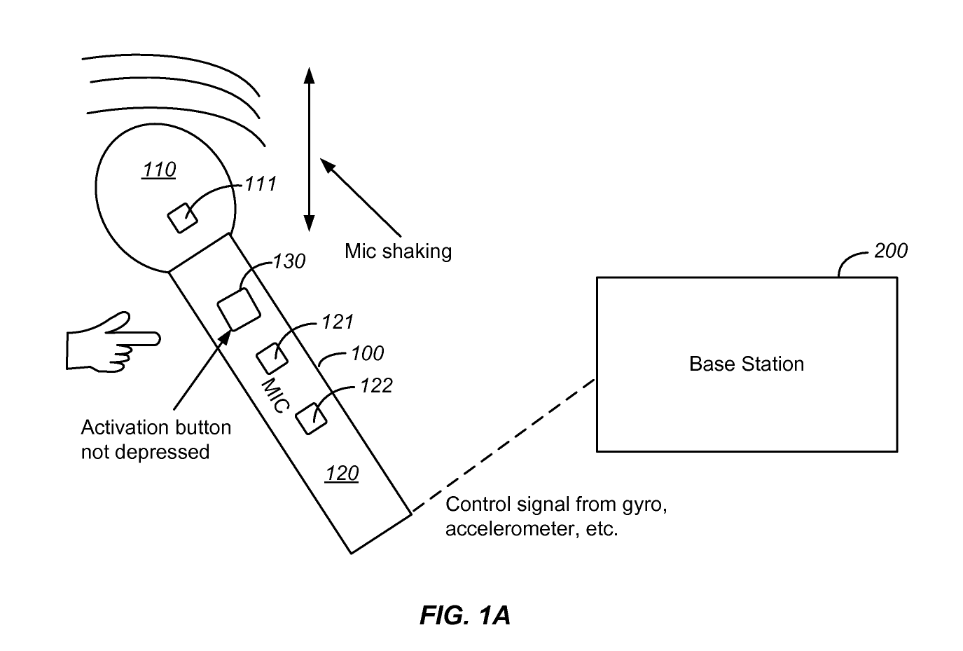

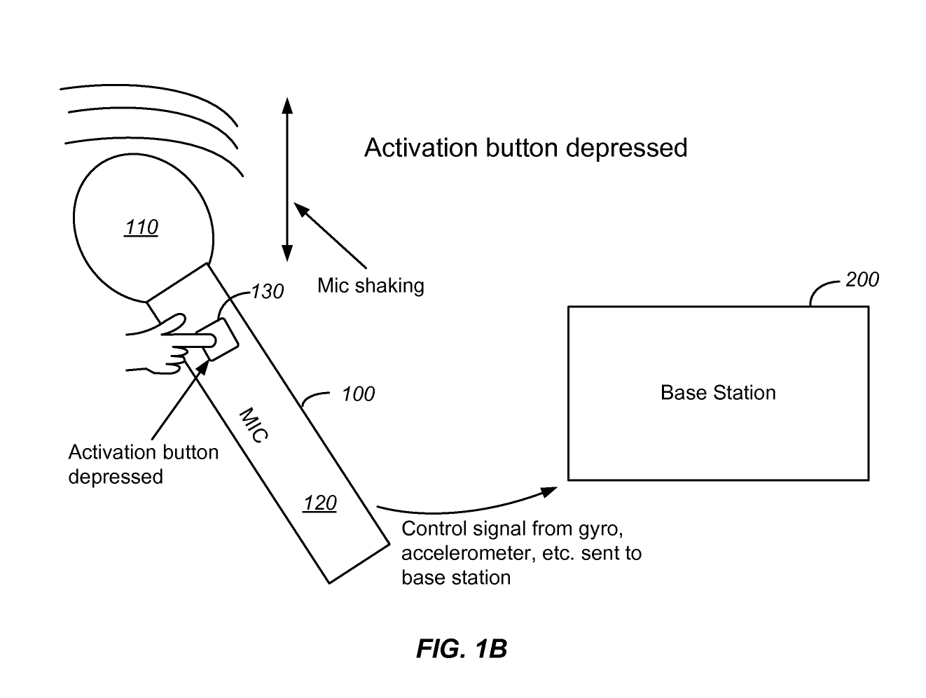

FIGS. 1a and 1b each show a schematic representation of a microphone system according to a first embodiment,

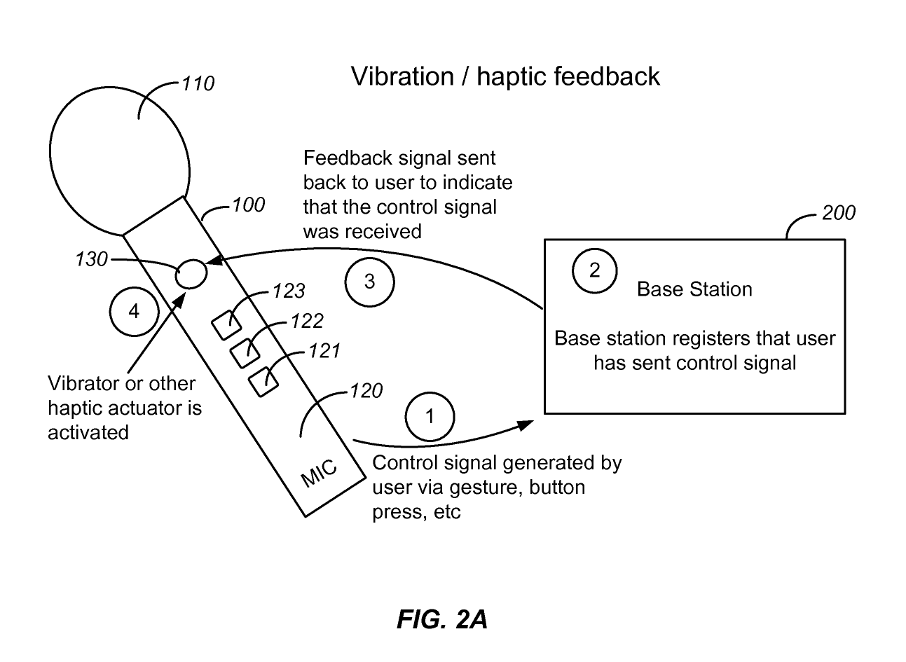

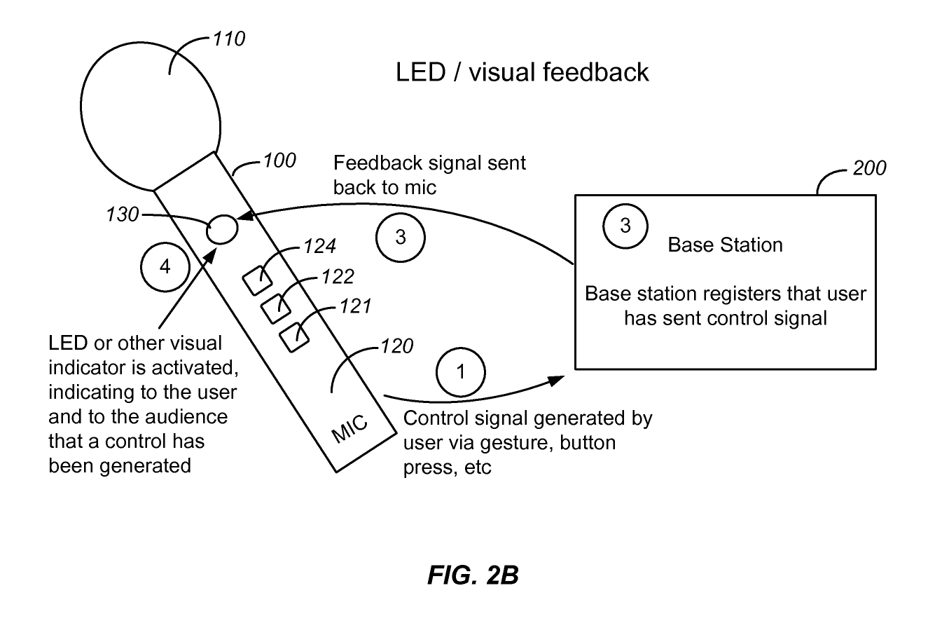

FIGS. 2a and 2b each show a schematic representation of a microphone system according to a second embodiment,

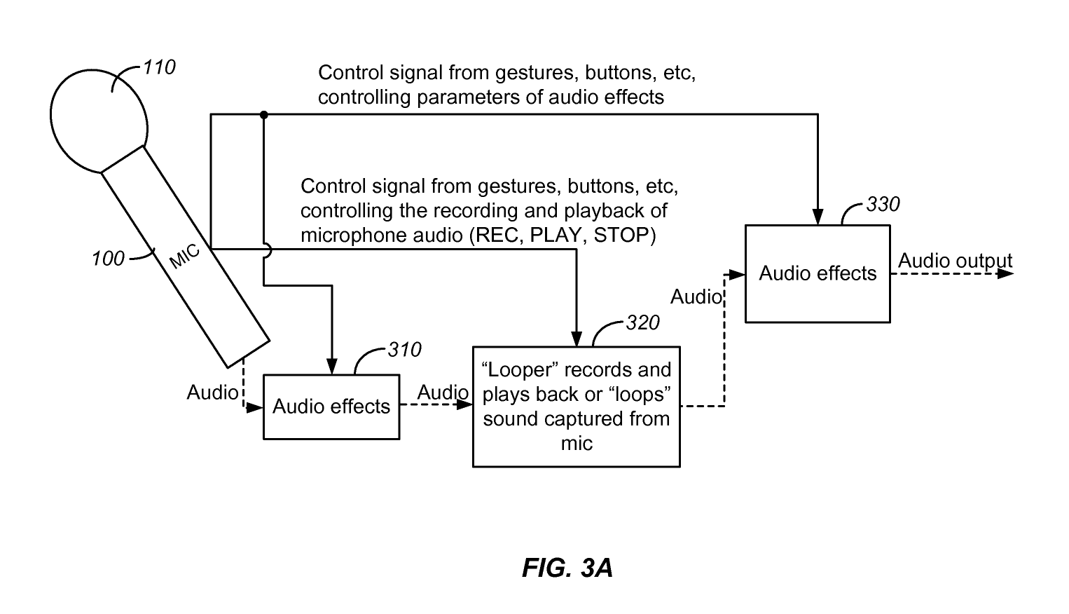

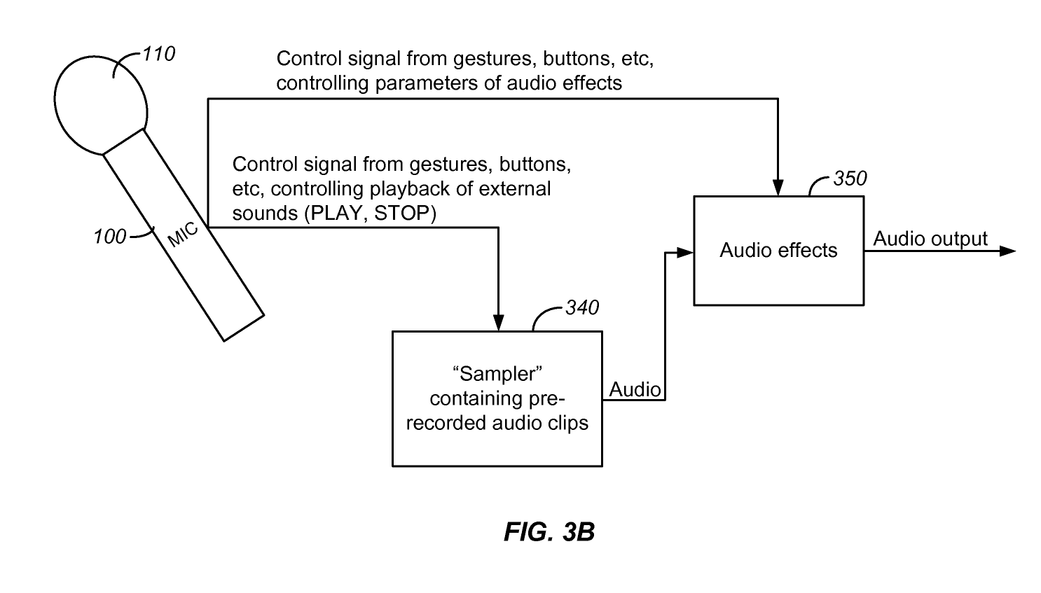

FIGS. 3a and 3b each show a schematic representation of a microphone system according to a third embodiment,

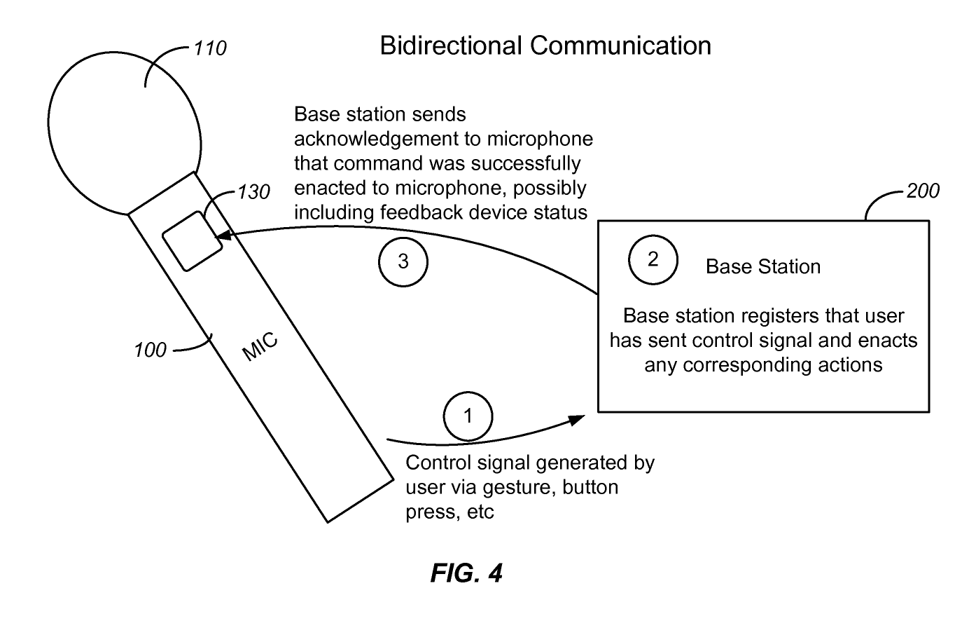

FIG. 4 shows a schematic representation of a microphone system according to a fourth embodiment,

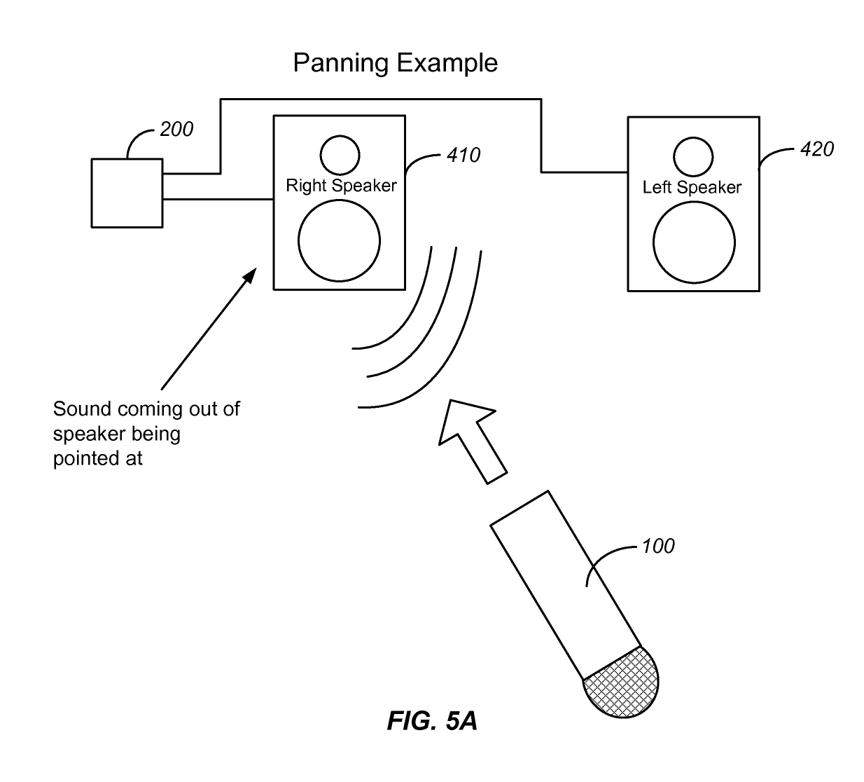

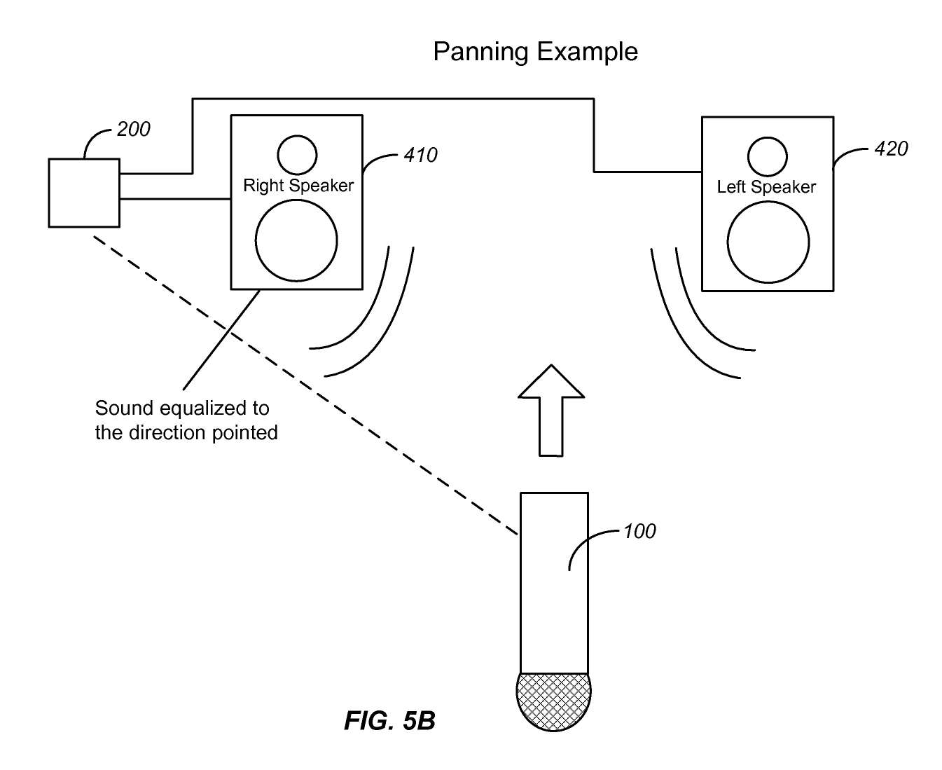

FIGS. 5a and 5b each show a schematic representation of a microphone system according to a fifth embodiment,

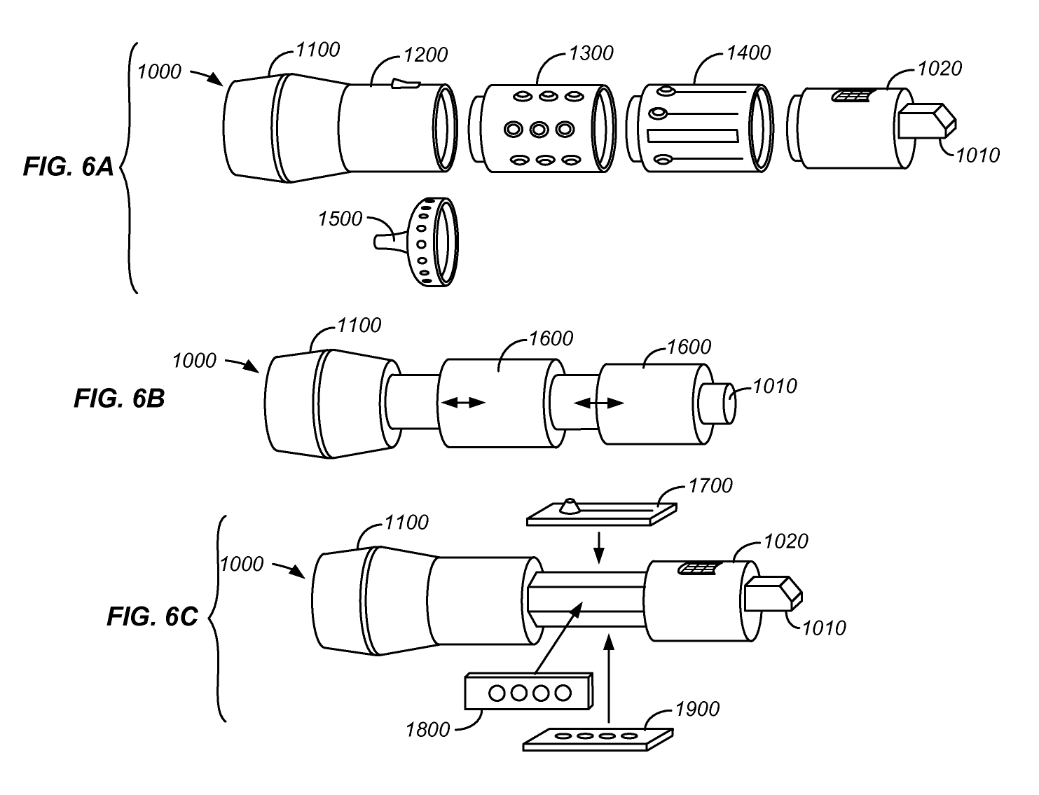

FIGS. 6a to 6c each show schematic representations of a hand-held microphone according to a sixth embodiment,

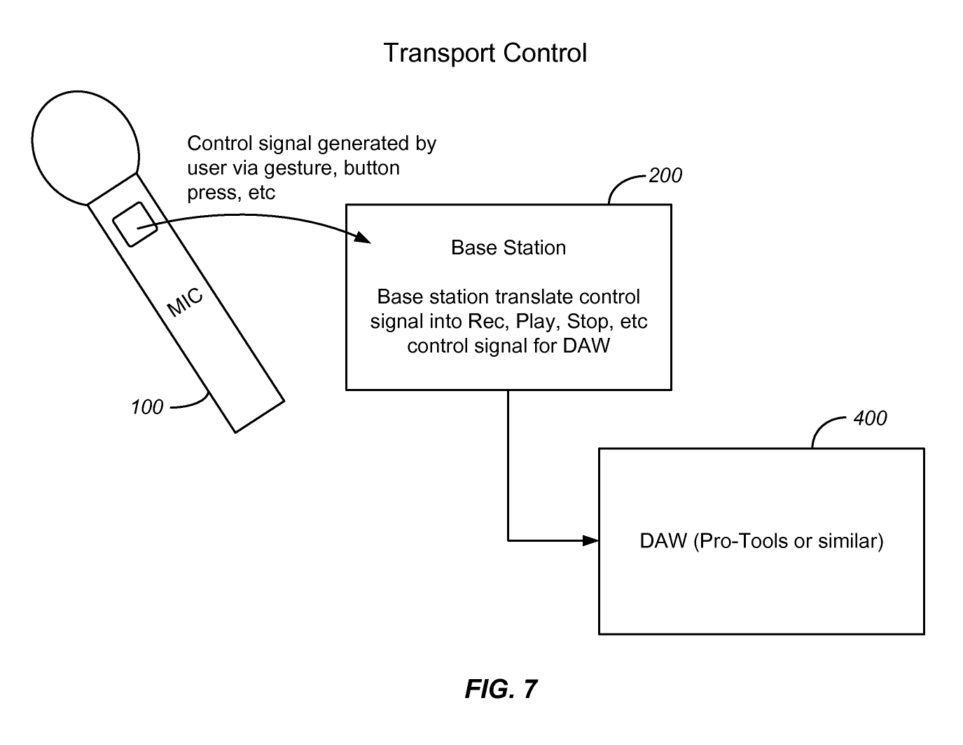

FIG. 7 shows a schematic representation of a microphone system according to a seventh embodiment,

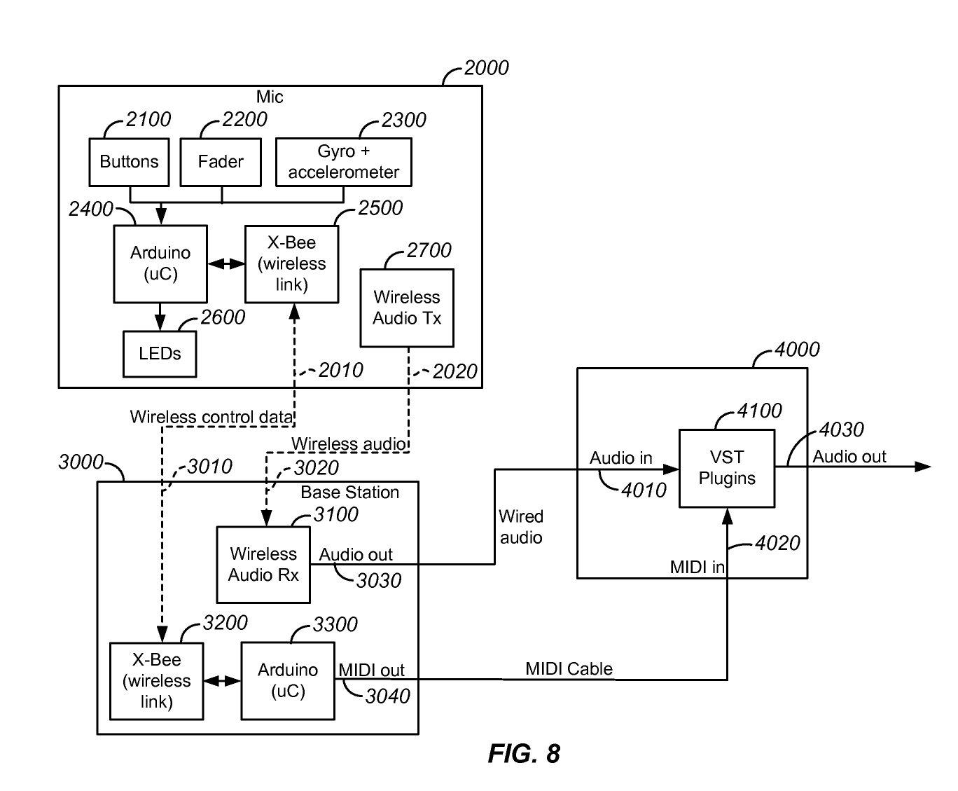

FIG. 8 shows a block diagram of a microphone system according to an eighth embodiment,

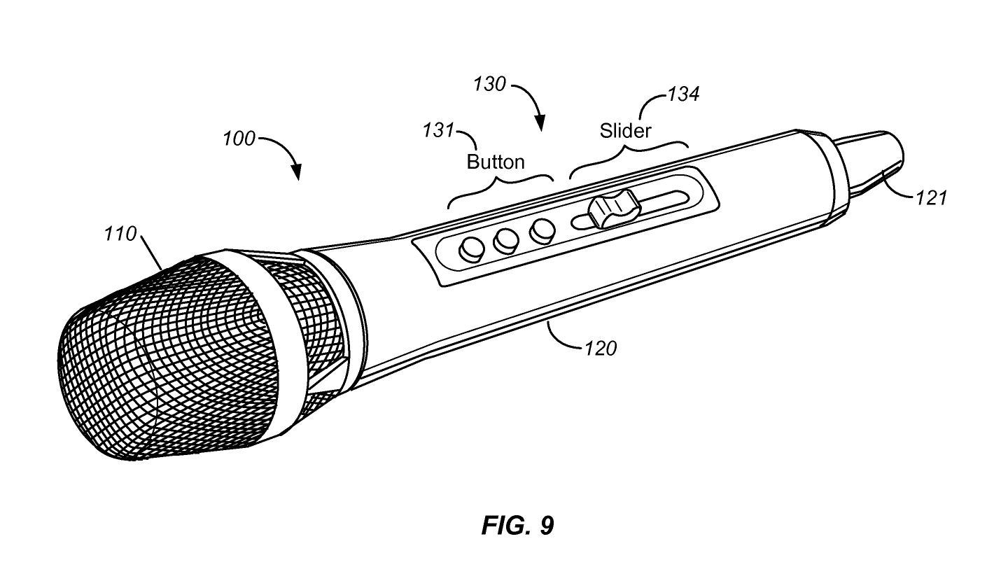

FIG. 9 shows a schematic representation of a hand-held microphone according to a ninth embodiment,

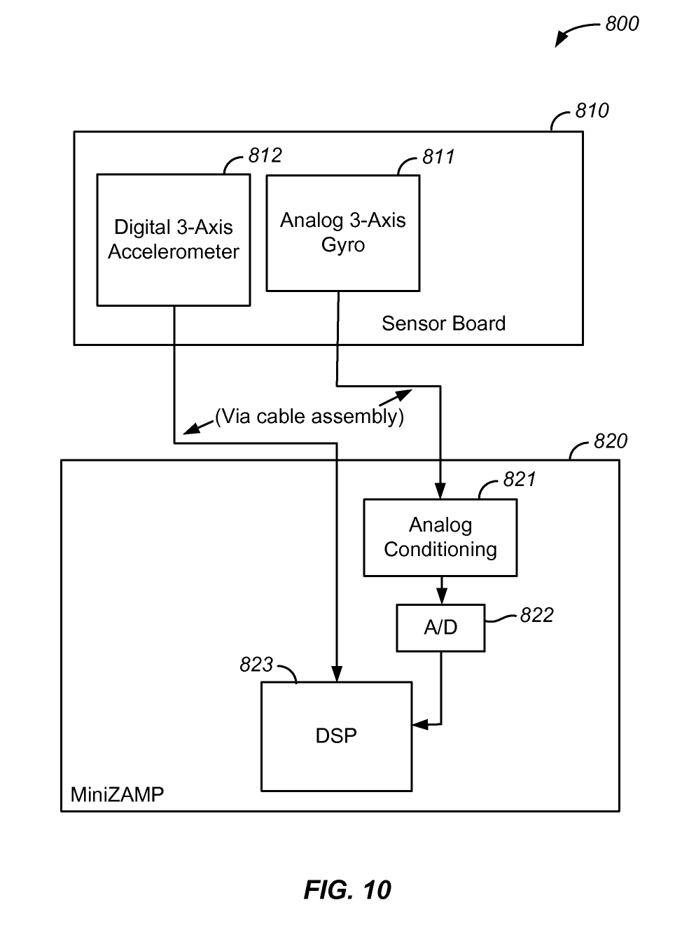

FIG. 10 shows a block diagram of a hand-held microphone according to a tenth embodiment,

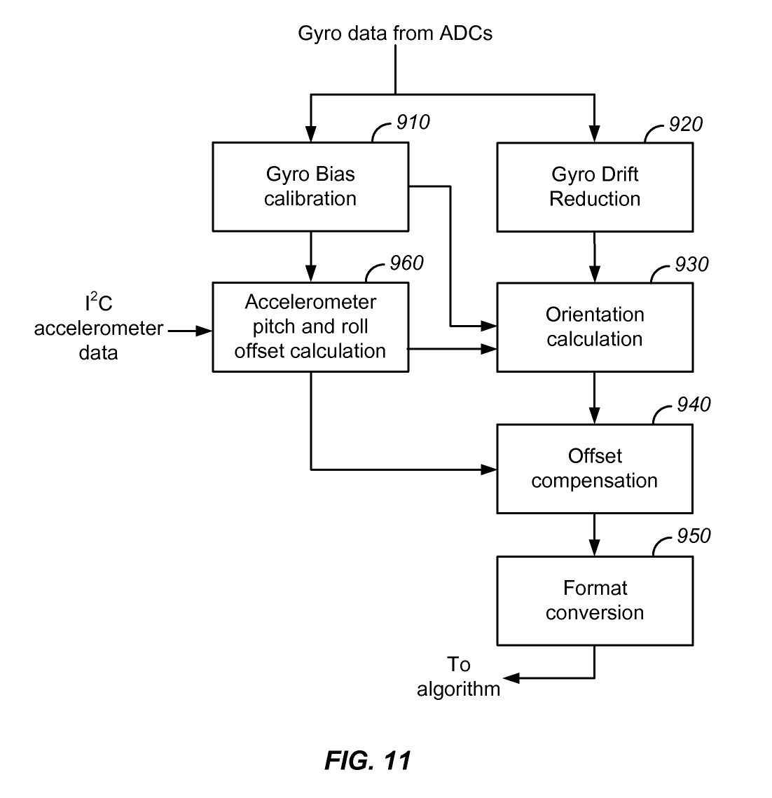

FIG. 11 shows a block diagram of the control of a microphone system according to an eleventh embodiment.

FIGS. 1a and 1b each show a schematic representation of a wireless hand-held microphone system according to a first embodiment. The microphone system according to the first embodiment comprises at least one hand-held microphone 100 and a base station 200. The communication between the hand-held microphone 100 and the base station 200 can be performed wirelessly or over cables. The hand-held microphone 100 comprises a microphone head 110 which receives a microphone capsule 111 for detecting audio signals. The hand-held microphone 100 furthermore comprises a microphone handle 120 with an activation unit (button) 130. The microphone 100 also comprises a motion detection unit 122 for detecting a motion of the microphone handle. This motion detection unit 122 may comprise an accelerometer and a gyro sensor. The output (control signals) of the motion detection unit 122 can be forwarded to the base station 200 wirelessly or via cables. In other words, those control signals will indicate the motion or gesture of the microphone. This information can be used to control the operation of the microphone and/or to influence or manipulate the signal processing of the output signals of the microphone either in the hand-held microphone 100 or in the base station 200.

The motion detection unit 122 can be activated or deactivated by the activation button 130. Alternatively, the forwarding of the output signals of the motion detection unit 122 towards the base station can be activated or deactivated by the activation button 130.

The motion detection unit 122 can detect any gestures or any movements of the microphone 100, e.g. microphone shaking. These gesture information or motion information can be used to control the operation of the microphone 100 or the base station 200 or the audio signal processing of the output signals of the microphone. Alternatively or additionally, the output signals of the motion detection unit 122 can also be used to control additional devices which can be directly or indirectly connected to the base station. Such devices may include the lighting environment, the air conditioning or other non-audio devices.

FIGS. 2a and 2b each show a schematic representation of a microphone system according to a second embodiment. The hand-held microphone according to the second embodiment substantially corresponds to the hand-held microphone according to the first embodiment. Additionally, a vibrator or haptic actuator 123 can be provided. When the activation button or element 130 is activated, the output signal from the motion sensing unit 122 will be forwarded to the base station. After the receipt of these control signals, the base station 200 will forward a feedback signal to the hand-held microphone 100 again. Upon receipt of this feedback signal, the vibrator or the haptic actuator 123 can be activated to indicate that the control signal has been received by the base station.

Alternatively and/or additionally, as shown in FIG. 2b, the hand-held microphone may comprise a visual indicating unit 124 to indicate that a feedback signal has been received by the base station indicating that the base station has in turn received a control signal from the hand-held microphone. The visual indicator unit 124 can be implemented as a light-emitting device LED and can be used to indicate to the user or the audience that the base station 200 has received the control signals from the hand-held microphone to implement a feedback.

The feedback signal from the base station 200 can also be used to adapt the lighting system to indicate to the audience that the base station has received a control signal from the hand-held microphone.

FIG. 3a shows a schematic representation of a microphone system according to a third embodiment. The microphone system according to the third embodiment comprises a hand-held microphone 100 and an audio processor unit 300 which can comprise a first audio effects unit 310, a audio processing unit 320 and a second audio effects unit 330. The hand-held microphone 100 according to the third embodiment can be based on the hand-held microphone according to the first or second embodiment. The audio output of the microphone 100 is forwarded to the first audio effects unit 310 which can manipulate the output signals of the microphone. The output of the first audio effects unit 310 can be forwarded to the audio processing unit 320 which can perform an audio processing on the received audio signals. The output thereof can be forwarded to a second audio effects unit 330 which can also perform certain audio manipulations. A hand-held microphone will also output control signals which are generated by the motion detection unit 122 if the motion-detection unit has been activated by the activator unit or by a movement or gesture at the microphone. Based on these control signals, the first and second audio effects unit and the audio processing unit 320 can manipulate or adapt the audio signals.

FIG. 3b shows a further schematic representation of a microphone system according to the third embodiment. In addition to the hand-held microphone 100 which can be based on the hand-held microphone according to the first or second embodiment, the microphone system comprises a second audio processing unit 340 and an audio effects unit 350. The second audio processing unit 340 can be used to sample received audio signals and to perform a audio processing thereon which contain pre-recorded audio clips. The operation of the second audio processing unit 340 is controlled by control signals of the microphone 100. The operation of the audio effects unit 350 is also controlled based on control signals from the microphone.

FIG. 4 shows a schematic representation of a microphone system according to a fourth embodiment. The microphone system according to the fourth embodiment can be based on the microphone system according to the first, second or third embodiment. Accordingly, the hand-held microphone 100 with a microphone head 110 and an actuation button 130 is provided. Audio output signals as well as the control signals from the hand-held microphone are forwarded to the base station 200. The base station 200 will register if control signals have been received and will perform an audio processing according to or based on the control signals. The base station will, however, also send an acknowledgement to the hand-held microphone indicating that the control signal has been received and the base station 200 has acted accordingly. This may also include a feedback of the device status.

According to the invention, the control signals of the microphone can also be used to control non-audio effects such as light, smoke, visual displays, fireworks and other non-audio experiences received by the audience.

FIGS. 5a and 5b each show a schematic representation of a microphone system according to a fifth embodiment. The microphone system comprises a hand-held microphone 100, a base station 200 and a left and right speaker 420, 410. The left and right speaker 420, 410 are used to output audio signals. The hand-held microphone 100 according to the fifth embodiment can be based on a hand-held microphone according to the first, second, third or fourth embodiment. Therefore, the microphone 100 will output control signals generated by the motion detection unit 122. These control signals can be used by the base station 200 to control the operation of the left and right speaker 420, 410. For example, if the microphone is pointed towards the right speaker, then respective control signals will be generated by the motion detection unit 122 and be sent to the base station 200. The base station 200 will initiate an adapted reproduction of the audio signals in such a way that the sound e.g. is only or partly coming out of the right speaker 410 to which the microphone is pointing. Alternatively, if the microphone is pointing into the middle between the left and the right speaker as indicated in FIG. 5b, both speakers will output the respective sound signals.

FIG. 6a-6c each show a schematic representation of a hand-held microphone according to a sixth embodiment. According to the sixth embodiment, different control units or elements can be attached to separate detachable mechanical elements. These elements can be mounted on the handle of the microphone. In addition or alternatively, the control elements may also form part of the microphone handle. By providing a number of mechanical segments, the user can operate the segments to achieve a manipulation of the audio sound.

As shown in FIG. 6a, the hand-held microphone 1000 according to the sixth embodiment comprises a microphone head 1100, a motion detection segment 1200, optionally a knob segment 1300 with a plurality of knobs, optionally a slider segment 1400 having at least one slider and optionally a transmission and battery segment which may comprise an antenna 1010 and which can receive a battery or accumulator for the hand-held microphone. Alternatively to the microphone head, a mouth piece 1500 can be used. In this case, the hand-held microphone can be used as some kind of musical instrument, if the user is blowing into the mouth piece 1500.

Optionally, the hand-held microphone can also comprise further motion sensors, turning volumes, squeezing force detectors and the like to manipulate the output audio signals upon activation of these units.

FIG. 6b shows a further example of the sixth embodiment. The hand-held microphone 1000 comprises a microphone head 1100 as well as at least one ring segment 1600 which can be slided along the axis of the microphone handle. The sliding of these ring segments will generate a control signal which can be used to manipulate the audio signal outputted by the hand-held microphone.

FIG. 6c shows a further example of the sixth embodiment. The hand-held microphone 1000 comprises a microphone head 1100 as well as a recess, onto or into which different segments can be mounted. Such segments can be a slider segment 1700, a knob segment 1800 or a motion detection segment 1900. All of these segments can be attached to the recess in the microphone handle and can be used to generate control signals based on which the output audio signal can be manipulated.

The hand-held microphone according to the first to sixth embodiment is able to detect a movement of the microphone or a movement of the fingers holding the microphone. This movement can be translated into control signals which can be used to manipulate the output signals of the microphone.

In order to translate the movements of the microphone or the fingers of the user into processable data, optionally two interfaces can be provided either in the base station or in the handle of the hand-held microphone. The first interface is a translation of a one-dimensional parameter into data. This can be for example the location, the speed, the acceleration, etc. This is translated into an input data range, for example 0-127 for a MIDI interface or into zeros and ones. The second interface relates to a translation of multi-dimensional parameter curves to data to provide a gesture recognition. The hand-held microphone is able to detect and process one-dimensional movement data or gesture recognition data. The one-dimensional movement data is mapped in order to allow the user to define a maximum and a minimum parameter, for example for the excursion, speed, force, button click speed, etc. to a minimum and maximum control data space (e.g. 0-127). The process parameter movement data can be filtered and smoothed with adjustable filter settings.

The multi-dimensional data translation (gesture recognition) can be performed in the base station or in the handle of the hand-held microphone. A pattern recognition unit can be provided to detect and record several gesture patterns to learn to understand a human gesture and to combine this gesture with a trigger action. The gesture patterns may comprise a set of linear motion data recorded over a predetermined amount of time. This can for example be used to train multi-modal gestures or dedicated action triggers (e.g. double touch, shake and turn, the “limbo flip” etc.).

Optionally, a control unit can be provided in the base station or in the handle of the hand-held microphone in order to individualize the intensity of the hand movement data to control data of the subsequent action devices. Therefore, this control unit enables a movement to activity translation in order to adjust to the individual habits of moving, turning, sliding fast or slow. Moreover, it can artificially accelerate a gesture to an intensified control action. The slider speed and push button clicks and double clicks have to be adjusted to the desired actions.

According to the invention, the hand-held microphone comprises an open application interface. This can deliver access to a motion data bus and a control data bus as well as to the audio data.

FIG. 7 shows a schematic representation of a microphone system according to a seventh embodiment. The microphone system comprises a hand-held microphone 100, a base station 200 and a digital audio workstation DAW 400. The microphone 100 and the base station 200 can correspond to the microphone and base station according to the first, second, third, fourth, fifth or sixth embodiment. The hand-held microphone 100 will not only provide audio data but also control data or control signals according to the movement of the microphone. The audio data as well as the control data are forwarded to the base station which can translate the control signals into control signals for the digital audio work station 400. In other words, the hand-held microphone can be used to control the operation of the digital audio workstation 400.

FIG. 8 shows a block diagram of a microphone system according to an eighth embodiment. The microphone system comprises a microphone 2000, a base station 3000 and optionally an audio processing unit 4000. The microphone 2000 and the base station 3000 according to the eighth embodiment can be based on any of the microphones and base stations according to the first to seventh embodiment.

The hand-held microphone 2000 comprises at least one button 2100, optionally a fader 2200 and a motion detection unit 2300 which may comprise a gyro sensor and an accelerator. The microphone furthermore comprises a microprocessor 2400 for handling the communication, control and command processing. The hand-held microphone 2000 furthermore comprises a wireless transceiver 2500 and a second wireless audio transceiver 2700. The hand-held microphone 2000 can also comprise a display or light emitting diodes 2600.

The base station 3000 comprises a first wireless transceiver 3200 communicating with the first wireless transceiver 2500 of the microphone 2000 as well as a second wireless transceiver 3100 which can communicate with the second wireless audio transceiver 2700 of the microphone 2000. In addition, the base station 3000 comprises a microprocessor 3300 which is handling the communication, control and command processing. The microprocessor 3330 comprises an output 3040 which is forwarded for example via a midi cable to an input of the audio processing unit 4000. The audio processing unit 4000 may comprise plug-in units 4100 into which different processing algorithms can be stored. Based on these algorithms, the audio output 3030 from the base station can be processed and the processed audio signals 4030 can be outputted.

In the following, the communication will be described in more detail. The base station 3000 can send one byte to the microphone 2000 containing one bit which is signalling a request for control data as well as five bits indicating which LED should be activated. This byte can also be referred to as a request byte. Then the hand-held microphone 2000 receives this request byte and activates the required light emitting diodes. Then, the microphone returns an eight bit sequence as the control sequence containing the status of all buttons, the value of the fader and the last processed values of the motion detection unit 2300. The base station in turn receives these control signals and based on this sequence, it determines what the user wishes to do. Then the base station 3000 can generate a midi message and send this midi message to the receptor. Thereafter, the base station can send a further request byte to the microphone and the process will continue again.

The first bit in the request byte can be for example a command request and the second to sixth bit can relate to the status of the first to sixth LED. The seventh bit can be reserved. The control signal bytes may comprise seven byte wherein byte 0 relates to the button status, byte 1 relates to the fader value, byte 2 relates to the gyro in x axis, byte 3 relates to the gyro in y axis, byte 4 relates to the gyro in z axis, byte 5 relates to the accelerator in x axis, byte 6 relates to the accelerator in y axis and byte 7 can relate to the accelerator in z axis. The button status byte may comprise seven byte, wherein the byte 0 relates to the button 1 status, bit 1 relates to the button 2 status, bit 2 relates to the button 3 status, bit 3 related to the button 4 status, bit 4 relates to the button 5 status, bit 5 relates to the activation button status, and bit 6 and 7 can be reserved.

In the accelerometer controller, if gestures and controls are only using the raw accelerometer data, a drift is not a problem. The accelerator data can be used to activate a shaker plug-in. This plug-in can create a stochastic maraca or shaker sound with an input parameter which leads to the change in the accelerometer data as a function of time. Furthermore, accelerometer thresholds can be used e.g. for first pump explosions, etc.

When the accelerometer passes a certain threshold (e.g. 1,5 G), a sample is played or an event is triggered.

According to the invention, optionally a reset button may be present on the hand-held microphone. If this button is activated or pressed, the gyro and accelerometer data are reset. For example, all angles are set to zero if the reset button is depressed. When this is performed, the current microphone position is at zero yaw, zero pitch and zero roll. This can be advantageous to obtain a relative positioning. Alternatively, when the reset button is activated, the yaw and roll angles are set to zero degrees but the pitch is set to the angle in which the microphone is actually oriented with respect to the horizontal direction. Here, the accelerometer data can be used and the pitch can be determined as described later with respect to FIGS. 10 and 11.

Alternatively, the reset button and the activation button can be the same. This is advantageous as soon as the gyro and accelerometer data are activated, the gyro motion begins from a zero yaw and roll angle.

FIG. 9 shows a schematic representation of a hand-held microphone according to a ninth embodiment. The microphone comprises a microphone head 110, a microphone handle 120 and an antenna 121. In the microphone handle, several buttons 131 and a slider 134 are implemented as buttons which can be used for activation or manipulation of the audio signals outputted by the microphone. In addition, the hand-held microphone according to the ninth embodiment can be based on the hand-held microphone according to the first to eighth embodiment.

FIG. 10 shows a block diagram of a hand-held microphone according to a tenth embodiment. The hand-held microphone 800 according to the tenth embodiment (which can be based on the microphone according to the first to ninth embodiment) can comprise a sensor board 810 with for example an analogue three-access MEMS gyroscope 811 and for example a digital three-access MEMS accelerometer 812. The gyro sensor 811 is used to determine the angular orientation of the microphone when it is rotating. The accelerometer 812 is used to determine the orientation relative to the direction of gravity (down) when the user resets the tracker.

A micro-processor 820 can be provided in the hand-held microphone or in the base station. The micro-processor 820 can provide an analogue conditioning unit 821, an analogue digital transducer 822 and a digital signal processing unit 823. The digital signal processing unit DSP receives the output from the accelerometer and the gyro sensor can calculate the orientation of the microphone. For example at startup, the gyro sensor bias can be calibrated. The initial pitch angle of offsets of the sensor of the accelerometer data can be calculated. A gyro data drift reduction can be performed. A scaling is performed to convert the raw gyro voltage into rad/s. The gyro data is converted into orientation data. A compensation is performed for the gyro based orientation or for initial offsets. The orientation data is converted to a yaw, pitch, roll format.

FIG. 11 shows a block diagram of the control of the microphone system according to an eleventh embodiment. The gyro data are forwarded to a gyro-bias calibration step 910 as well as a gyro-drift reduction step 920. The output of the gyro-bias calibration step 910 and the gyro-drift reduction step 920 are forwarded to the orientation calculation step 930. The data from the accelerometer is processed in the accelerometer pitch and control offset calculation step 960. The output thereof is also forwarded to the orientation calculation step 930. The output of the orientation calculation step is forwarded to an offset compensation step 940 and the output of the offset compensation step 940 is forwarded to the format conversion step 950. The output thereof will then be forwarded to the tracking step.

In the following, the steps as shown in FIG. 11 are explained in more detail.

In the gyro-bias calibration step 910, the output voltages of the gyro sensors are proportional to the angular velocity of the each of the axes. The output voltage when the gyro is held perfectly still is called the zero-level, or bias. This bias level is dependent on many factors, including temperature, and must be re-calculated each time the tracker is powered up. Because the gyro data is being integrated, the bias level must be accurately acquired.

To perform the calibration process, when the tracker is powered on, the algorithm simply averages together the first 3000 data samples from each axis (about 10 seconds). This average value is the bias level. This bias will later be subtracted from the data prior to integration. The sensors should remain perfectly still during this calibration period, which lasts about 10 seconds.

The sensitivity S₀ of the gyro sensor is e.g. 3.2 mV per degree per second. The A/D converter on the microprocessor 820 has e.g. a range R_{ADC} of 2.8V. Assuming the analog gyro voltage is biased in the center of the A/D's range (which is done coarsely through analog conditioning and more precisely in the bias calculation described below), then the scale factor used to bring the data into rad/s units is simply

$${s}_{f} = ( \frac{{R}_{ADC}}{2 {S}_{0}} ) ( \frac{π}{180} ) = 7.6358 .$$

This assumes that the digital data from the A/D is normalized to the −1 to 1 range.

When the motion tracker, i.e. the motion detection unit according to the invention, is first started up, or when the user presses the reset button, the tracker needs to know the orientation of the sensor at this time. This information is required because different users may hold the microphone in different ways, and the sensor may not be oriented at the origin. Since the goal of motion-tracking is to track the orientation of the microphone, the relationship of the tracker to the microphone must be acquired.

Because gyro sensors have no ability to measure absolute orientation, an accelerometer is used for this purpose. Accelerometers output the acceleration from each of its 3 axes. When the accelerometer is held perfectly still, it shows the effect of gravity on each of its 3 axes. This allows the tracker to know which way is down, and therefore the pitch and roll of the sensor. The initial yaw offset cannot be measured in this way, but it is assumed that the tracker yaw and the head yaw do not differ significantly, and so the initial yaw offset can be set to zero.

Converting the accelerometer data into an orientation is described below. The first step is to convert the raw data into pitch and roll, as follows:

θ=−a tan 2(x,\sqrt{y²+z²}) (1)

and

φ=a tan 2(y,z) (2)

where θ is pitch, φ is roll, and ψ=0 is yaw. The negative sign in Eq. 1 is required to account for the fact that positive pitch is looking down.

Once this is calculated, it must be converted into a quaternion. With yaw set to zero, this becomes

$${q}_{0} = [ \begin{matrix}{q}_{00} \\ {q}_{01} \\ {q}_{02} \\ {q}_{03}\end{matrix} ] = [ \begin{matrix}cos ( \frac{φ}{2} ) cos ( \frac{θ}{2} ) \\ sin ( \frac{φ}{2} ) cos ( \frac{θ}{2} ) \\ cos ( \frac{φ}{2} ) sin ( \frac{θ}{2} ) \\ - sin ( \frac{φ}{2} ) sin ( \frac{θ}{2} )\end{matrix} ] . \qquad ( 3 )$$

As previously mentioned, gyro sensors suffer from drift. Since the main goal of this head-tracker project is to keep complexity and cost to a minimum, the Kalman filter-based sensor fusion approach was not desirable. Instead, a simple algorithm applied directly to the gyro data can be used in the gyro drift reduction step 920.

One such drift reduction algorithm, called Heuristic Drift Reduction (HDR) was developed for navigation at the University of Michigan. This technique effectively uses a binary integral controller as part of a closed feedback loop to estimate and subtract the drift from the measurement.

According to the invention, a slightly modified version of the aforementioned technique is used, which is described hereinafter.

Consider our true angular rate, ωₜᵣᵤₑ, which should be measured for one body axis of rotation. The data we get from that axis' output on the gyro is

ω_{raw}[i]=ωₜᵣᵤₑ[i]+ε₀+ε_{d}[i] (4)

where ω_{raw} is the raw measured data from the gyro, ε₀ is the static bias measured at startup, and ε_{d} is the drifting component of the bias which is inherent in gyro sensors and which we want to eliminate.

The first step is to remove the static bias from every data sample:

ω′_{raw}[i]=ω_{raw}[i]−δ₀ ,(5)

The goal, then, is to find a correction factor I that can be added to the raw data to compensate for the drift, as

ω[i]=ω′_{raw}[i]+I[i] (6)

where ω is the corrected angular rate value.

The basic HDR algorithm uses a binary integral controller to calculate this correction factor. It assumes no angular motion, or a “set point” (ωₛₑₜ) of zero. It then calculates an estimated error signal E as

E[i]=ωₛₑₜ[i]−ω[i−1], (7)

Since ωₛₑₜ=0, the error signal is just the negative of the previous rate output. A typical integral controller can be sensitive to the error signal, however, and in reality the sensor will not be perfectly still and will be noisy, and so instead of adjusting the correction factor by the magnitude of E, it only adjusts the correction factor by the sign of E, thus making it a binary controller. The correction factor can then be written as

$$I [ i ] = \{ \begin{matrix}I [ i - 1 ] - {i}_{c} & for ω [ i - 1 ] > 0 \\ I [ i - 1 ] + {i}_{c} & for ω [ i - 1 ] < 0\end{matrix} \qquad ( 8 )$$

where i_{c} is a fixed adjustment increment. This can also be written as

I[i]=i[i−1]−sign(ω[i−1])i_{c} ,(9)

This approach by itself works well to reduce the drift of a stationary sensor. However, when the sensor starts moving the output becomes inaccurate because the controller sees it as drift. A solution to this is to “turn off” the integral controller when the magnitude of the gyro data exceeds a certain threshold, which is an indication of significant sensor movement. In this case, the correction factor I can be written as

$$\begin{matrix}I [ i ] = W [ i ] ( I [ i - 1 ] - sign ( ω [ i - 1 ] ) {i}_{c} ) \\ where & ( 10 ) \\ W [ i ] = \{ \begin{matrix}1 & for ω [ i - 1 ] < θ \\ 0 & otherwise\end{matrix} & ( 11 )\end{matrix}$$

and θ is the threshold, such that if a data point is larger than the threshold, motion is said to be occurring.

Another case to consider is when there is slow and steady movement, which may not result in signals above the threshold. A good indication of a slow, steady turn is that the output signal ω will keep the same sign over several sampling periods. This can be handled by slowly decreasing the effect of the increment factor i_{c} each period that the sign of ω remains constant. The corrected angular rate output is then written as

$$\begin{matrix}I [ i ] = W [ i ] ( I [ i - 1 ] - sign ( ω [ i - 1 ] ) {i}_{c} R [ i ] ) \\ with & ( 12 ) \\ R [ i ] = \frac{1 + {c}_{1}}{1 + {c}_{1} r [ i ] {c}_{z}} , & ( 13 )\end{matrix}$$

where c₁ and c₂ are tunable constants and

$$r [ i ] = \{ \begin{matrix}r [ i - 1 ] + 1 & for sign ( ω [ i - 1 ] = sign ( ω [ i - 2 ] ) \\ 1 & otherwise .\end{matrix} \qquad ( 14 )$$

In practice, the algorithm implemented on the microprocessor 820 is in the form of Eqs. (11) through (14). This process is applied to each of the three independent axis-outputs of the gyro. The constant values which can be used are as follows in table 1.

TABLE 1

| Constant | Value |
|---|---|
| i_{c} | 0.00001 |
| c₁ | 0.01 |
| c₂ | 5.0 |

It should be noted that in the current implementation, the scaling of the data to rad/s second happens after the drift reduction. Ideally, this order should be reversed, such that the drift reduction parameters need not be changed if the sensitivity of the gyro changes.

Once the gyro data has been processed for drift reduction, it must be used to calculate the orientation of the tracker. This calculation is done using quaternions.

The gyro signal (after scaling to units of rad/sec) gives the angular rates of each its 3 axes in the body reference frame. The desired output is the orientation in the world reference frame. Since quaternions represent orientations in the world reference frame, the first step is to convert the angular body rates into world-frame quaternion rates, as follows [refs]:

q′₀=−0.5(Pq₁[i−1]+Qq₂[i−1]+Rq₃[i−1]+λq₀[i−1]

q′₁=−0.5(Pq₀[i−1]+Rq₂[i−1]+Qq₃[i−1]+λq₁[i−1]

q′₁=−0.5(Pq₀[i−1]+Rq₂[i−1]+Qq₃[i−1]+λq₁[i−1]

q′₁=−0.5(Pq₀[i−1]+Rq₂[i−1]+Qq₃[i−1]+λq₁[i−1]

q′₂=−0.5(Qq₀[i−1]+Pq₃[i−1]+Rq₁[i−1]+λq₂[i−1]

q′₃=−0.5(Rq₀[i−1]+Qq₁[i−1]+Pq₂[i−1]+λq₃[i−1] (15)

where

λ=1−(q₀[i−1]²+q₁[i−1]²+q₂[i−1]²+q_{q}[i−1]²) (16)

is a normalization factor which ensures that the quaternions are of unit length [ref],

q′=q′₀+q′₁i+q′₂j+q′₃k (17)

is the quaternion rate and P, Q and R are the (drift-compensated and scaled to rad/s) body roll, pitch, and yaw rates, respectively, measured from the output of the gyro. Although this processing is based on a right-handed coordinate system, as previously mentioned the gyro data is based on a left-handed reference frame, and so in order to make the calculations correct, the body pitch and yaw rates coming from the gyro must be negated. So in the algorithm, and are taken to be the negative of the scaled output of the drift reduction algorithm for pitch and yaw.

The quaternion rate is then numerically integrated to find the new orientation:

q[i]=q[i−1]+Tₚq′[i] (18)

where Tₚ is the sample period. The sample rate used according to the invention is approximately 300 Hz. It should be noted that under normal circumstances, quaternions cannot simply be added together to form rotations. However, given a high enough sample-rate, the quaternion derivatives can be assumed to be sufficiently small that the numerical integration of Eq. 17 satisfies a trigonometric small-signal approximation.

In the offset compensation step 940, the initial pitch and roll of the sensor is determined at start-up, and after each press of the reset button, while the yaw is always set to 0. This is used as the initial conditions for the integration, such that q [i−1] for i=0 is equal to q₀. This is to account for the fact that the user may not wear the headphone with the tracker perfectly level on the top of the head. The headband may be tilted forward, or to the side. This is important because the goal of the algorithm is to track the orientation of the user's head, not necessarily the orientation of the sensor board. It will be assumed that x-axis of the sensor is always aligned with the users head. (That is, that the x-axis of the sensor always points out the user's nose.) It will also be assumed that the user holds their head upright when pressing the reset button.

The orientation calculated using the above method is then the orientation of the sensor, but not necessarily of the head. The orientation which is reported to the SePA3D algorithm must be the orientation of the user's head, not just of the sensor. The initial orientation of the sensor when the user presses the reset button can be considered an offset rotation, and thus each time the orientation calculated above is reported to SePA3D it must first be rotated by the inverse of the offset orientation.

This rotation must be done in the body reference frame of the sensor. This means we must right multiply the quaternion calculated above by the inverse of the offset quaternion (using quaternion multiplication), as follows:

q_{c}=qq₀⁻¹ (19)

where q_{c} is the corrected orientation quaternion, and q₀⁻¹ is the inverse of the offset orientation quaternion, calculated at reset using the accelerometer data.

The final step (format conversion step 950) is to convert the corrected quaternion orientation into the yaw, pitch, and roll format so that this data can be used. This is done as shown in the section on quaternions [ref this]:

φ=−a tan 2(2(q₀q₁+q₂q₃),1−2(q₁²q₂²))

θ=a sin(2(q₀q₂−q₁q₃))

ψ=a tan 2(2(q₀q₃+q₁q₂),1−2(q₂²q₃²)) (20)

where φ is roll, θ is pitch, and ψ is yaw, all in the world reference frame. The negative sign in the calculation of roll is only required for the virtual surround processing, and will likely be removed pending further algorithm optimizations. Because this tracking processing is happening on the same processor as the rest of the processing, the transfer of these values to the algorithm is very simple, involving merely copying these values into the correct variables.

One important feature of the tracking system is the ability of the user to reset the angles to zero. Whenever the user presses the reset button, the software does the following.
Reads new offset data from accelerometer and calculates qₒ using Eqs (1)-(3).
Sets last orientation (q [i−1] for i=0) to q₀
Sends all zeros to 3D for yaw, pitch, and roll.

After this the algorithm proceeds as normal.

According to an embodiment of the invention which can be based on any of the previous embodiments, the balance point or center of gravity is in the area where a person typically will grip the microphone handle.

1. Microphone system, comprising:
at least one hand-held microphone and a base station, wherein audio signals detected by the hand-held microphone are forwarded to the base station,
wherein the hand-held microphone comprises a motion-detection unit for detecting a motion or a gesture of a hand-held microphone,
a control signal generating unit for generating control signals based on the detected motion or gesture,
wherein the hand-held microphone is adapted to forward the detected motion or gesture or the control signals to the base station,
wherein the output audio signal of the hand-held microphone can be manipulated based on the control signals,
wherein the hand-held microphone comprises an activation unit for activating or deactivating the motion detection unit or for activating or deactivating the transmission of the control signals.

2. Microphone system according to claim 1, wherein the base station is adapted to transmit a feedback signal to the hand-held microphone which can give a feedback to the user upon receipt of the feedback signal.

3. Microphone system according to claim 1, further comprising:
an audio processing unit for processing or manipulating the output audio signal of the microphone depending on control signals,
wherein the control signals are based on a motion or gesture of the microphone or the activation of buttons or sliders.

4. Microphone system according to claim 1, wherein
external devices coupled to the base station can be controlled based on the control signals.

5. Microphone system according to anyone of the claim 1, wherein
the motion detection unit comprises a three-axis accelerometer for detecting the acceleration of the microphone and
a three-axis gyro sensor,
wherein based on the output of the accelerometer and the gyro sensor, the control signals of the microphone are adapted.

6. Hand-held microphone for a microphone system, comprising:
a microphone head,
a motion detection unit for detecting a motion or a gesture of a hand-held microphone,
at least one segment having knobs or sliders which upon activation by a user influence the control signals of the hand-held microphone,
a control signal generating unit for generating control signals based on the detected motion or gesture,
wherein the hand-held microphone is adapted to forward the detected motion or gesture or the control signals to the base station, wherein the output audio signal of the hand-held microphone can be manipulated based on the control signals,
wherein the hand-held microphone comprises an activation unit for activating or deactivating the motion detection unit or for activating or deactivating the transmission of the control signals.

7. Method of controlling a microphone system having at least one hand-held microphone and a base station comprising the steps of:
forwarding audio signals detected by the hand-held microphone to the base station,
detecting a motion or gesture of the hand-held microphone,
generating control signals based on the detected motion or gesture of the hand-held microphone,
forwarding the detected motion or gesture or the control signals to the base station,
manipulating the output audio signals of the hand-held microphone based on the control signals, and
activating or deactivating the motion detection or the transmission of the control signals to the base station.
